(19) United States
(12) Patent Application Publication
(10) Pub. No.: US 2026/0187002 A1
(43) Pub. Date: Jul. 2, 2026

(54) HETEROGENOUS MESSAGE BUS

(71) Applicant: Wells Fargo Bank, N.A., San Francisco, CA (US)

(72) Inventors: Jeffrey A. Eugley, Tiburon, CA (US); Jason B. Price, Mt. Juliet, TN (US); Divya Anand, Mesa, AZ (US); Pardha S. Mutyala, Mountain House, CA (US); Christopher James Greer, St. Paul, MN (US); Murali Krishna Vemulapalli, San Ramon, CA (US); Lingaraju Ramasamy, Sunnyvale, CA (US); Tammy M. Oreglia, San Francisco, CA (US); Austin S. Bryant, Waukee, IA (US); Kameswara Sarma Mantha Venkata Subrahmanya, Livermore, CA (US)

(21) Appl. No.: 19/007,528

(22) Filed: Jan. 1, 2025

(51) Int. Cl. G06F 13/38; G06F 40/186

(52) U.S. Cl. CPC G06F 13/387; G06F 40/186

(57) ABSTRACT

System and techniques for implementing a message bus for heterogenous data sources are described herein. A message for a target process can be received. A template—that includes a set of required data fields or a set of restrictions—for the target process can be retrieved. The template can be used to detect whether the message is missing a value corresponding to a data field in the set of required data fields. If the value is missing, the value can be retrieved to create a more complete message that can be routed based on a field in the more complete message.

### TECHNICAL FIELD

Embodiments described herein generally relate to computer network communications and more specifically to a heterogenous message bus.

### BACKGROUND

A computer bus is a communication system that transfers data between components inside a computer or between computers. It acts as a shared medium through which data is transmitted between, for example a processor, memory, storage, peripherals, or other devices. The bus enables these components to exchange information in the form of electrical signals over a common set of pathways. There are different types of buses, such as the system bus, which connects to a central processing unit (CPU) and main memory, or peripheral buses like Peripheral Component Interconnect (PCI) or PCI Express (PCIe) that link expansion cards. Modern buses may also operate with different protocols or data transmission modes, such as parallel or serial communication.

Inter-device buses can be referred to as a network bus or a communication bus in networked systems. In inter-device communications, the bus facilitates data transfer and communication among multiple computers within a network. This type of bus enables the exchange of messages or data packets, enabling connected computers to communicate, share resources, or perform distributed processing. Examples include Ethernet, which acts as a network bus for local area networks (LANs), or message bus architectures in distributed systems, such as message queues that enable asynchronous communication between applications or systems across different computers. Between computers, an asynchronous message bus can facilitate communication across a distributed network using network protocols such as Message Queuing Telemetry Transport MQTT or Advanced Message Queuing Protocol (AMQP), enabling messages to be passed or routed without explicit timing coordination. In different implementations, nodes can independently initiate communication or respond to incoming messages based on this architecture.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for a heterogenous message bus, according to an embodiment.

FIG. 2 illustrates an example message flow, according to an embodiment.

FIG. 3 illustrates an example of component interaction, according to an embodiment.

FIG. 4 illustrates a flow diagram of an example of a method for a heterogenous message bus, according to an embodiment.

FIG. 5 is a block diagram illustrating an example of a machine upon which one or more embodiments may be implemented.

### DETAILED DESCRIPTION

Data based actions generally involve the collection of data and the performance of activity based on that collected data. When the data collection and the activity is well designed or controlled, the collected data can be appropriate for direct action. However, it is often the case that the data is transformed prior to action. This can result, for example, because different cameras produce different types or encoding of images, because old forms include or omit data used for action, etc. The longer running a data collection process, the greater the likelihood that a heterogenous set of data will be transformed into action data (e.g., data upon which actions can be based). Rectifying information from various sources or message pipelines poses several challenges, include issues with data inconsistency, data duplication, or formatting. For example, messages originating from web forms may contain data in a different structure compared to data submitted through an application programming interface (API) from a third-party source or phone call logs. Variations in field definitions, data validation practices, or input formatting can lead to discrepancies that must be resolved before the data can be acted upon (e.g., processing). Considering data collection for leads (e.g., a sales lead) duplication of leads across channels can occur—such as when a customer interacts with multiple intake mechanisms—and often invokes deduplication strategies or cross-referencing rules. Integrating information from activity monitoring may introduce additional complexities due to inconsistent or fragmented data, involving correlation of user behaviors with other lead details. Effective rectification relies on establishing a normalization process to align data from disparate sources into a coherent, unified format.

To address these issues, a heterogenous message bus can be used to collect data from a variety of different sources and manage data manipulation in a centralized facility. The data can then be routed to appropriate processing channels. For example, a message bus for collecting leads facilitates the intake and routing of data from multiple communication platforms into a centralized system. The heterogeneous bus handles incoming data from various sources, such as customers filling out web forms, submissions via an API from third-party referral partners, or phone call logs collected through telephony systems. The heterogeneous bus can support lead collection through activity monitoring mechanisms, such as user behavior tracking on web pages or application events that generate data. In an example, an intake source transmits lead information as messages, which the bus routes for processing or storage without requiring synchronization between the different intake mechanisms. This approach enables different systems or platforms to contribute data in a unified and asynchronous manner. Additional details and examples are provided below.

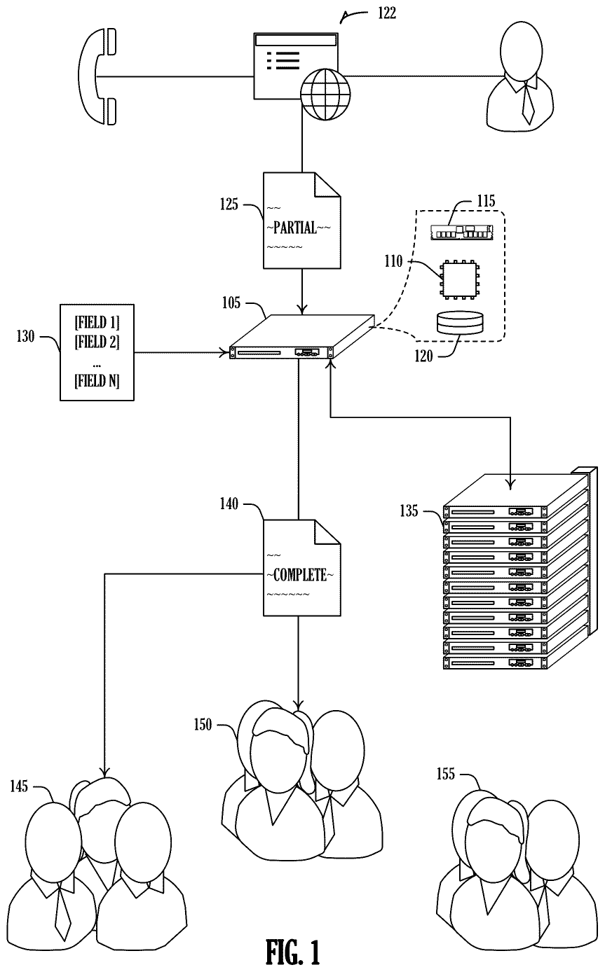

FIG. 1 is a block diagram of an example of an environment including a system 105 for a heterogenous message bus, according to an embodiment. The system 105 includes processing circuitry 110, storage 120 (e.g., power-stable storage such as a hard drive, solid state drive, etc.), and memory 115. The memory 115 is generally used to maintain running state information for the system 105 that is usually discarded between system power cycles or restarts. The memory 115 and the storage 120 are both forms of computer readable media. The processing circuitry 110—or software residing in the memory 115 or storage 120 executing on the processing circuitry 110—configure the system 105 to perform various operations when in running.

The system 105 is illustrated as connected (e.g., via a network) to a set of input devices 122, such as a telephone data entry system, a web site, or a human (e.g., employee) entering data into a data capture system. The set of input devices 122 provide a message 125 for a target process. Thus, the processing circuitry 110 is configured to receive the message 125 for the target process. The target process can be any variety of activities based on information in the message 125. For example, the target process can be a poll of political candidates and the message 125 is a questionnaire completed by a user and submitted through a web site.

The processing circuitry 110 is configured obtain (e.g., retrieve or receive) a template 130 for the target process. In an example, the template 130 includes a set of required fields. In an example, the template 130 includes a set of restrictions. The system 105 includes a database, an index, a lookup, or other association (e.g., data structure or service) to match the target process to the template 130. For example, the system 105 can include a registration an input device in the set of input devices 122 that corresponds the template 130 to messages originating from the set of input devices 122. In an example, the registration an include an indication (e.g., a message type) that is further used to distinguish the template 130 from other templates that also correspond to the set of input devices 122. In general, the template 130 is specific to the target process and perhaps to a particular one of the set of input devices 122 (e.g., a voice input device can have a different template than an API input device). In an example, the template 130 is stored on the system 105 (e.g., in the storage 120). In an example, the template 130 is stored externally to the system 105 (e.g., at a remote database or service).

The template 130 is used by the system 105 determine what, if any, information is needed for the target process and is missing from the message 125. For example, for a survey of residential opinions, the residential address can be a required field to geographically locate the data in the survey. Thus, the processing circuitry 110 is configured to detect that the message 125 is missing a value corresponding to a data field in the set of required data fields. In the illustrated scenario, the message 125 labeled “PARTIAL” because the template 130 included a required field that was missing from the message 125.

The processing circuitry 110 is configured to retrieve the value to create a more complete message 140. Here, the system 105 actively attempts to find the value missing from the message 125. In an example, the processing circuitry 110 is configured to retrieve the value from a local data store, such as held in the storage 120. Here, there can be data that is common to the set of input devices 122, for example, that can be applied to every incoming message. In an example, the missing data can include data that is available from other data in the message. For example, if the message has a first name, a last name, and a government identification (ID) number, but omits a residential address, this information can be sufficient to lookup the address. As noted earlier, such lookups can occur locally to the system 105. In an example, the lookup is remote, such as connecting to a remote service 135.

In an example, the template 130 includes default values for required fields. Here, it is possible to complete the message 125 via these values, or other information, in the template 130. In an example, a second message, in a different format than the message 125, can be received and converted to a second more complete message using the template 130. In an example, the format of the message 125 (e.g., the first format) is a data structure created by an API. In an example, the second format is a voice recording, a transcript, a video, an image of a paper form, or prose text.

In an example, an artificial neural network (ANN) model is invoked on the second message to extract values from the second message that corresponding to data fields of the template. This example notes that there can be situations where the message 125 contains the value but not, perhaps, in the field matched to the template 130. Consider a person who fills out a form, omits their name, but writes the name in a “comments” section of the form. Here, the ANN model can be used to extract the values, label them, or even determine whether data has been entered into the wrong fields (e.g., identify an address entered into a name field). In these examples, the processing circuitry 110 invoking the ANN model can fill in the missing value from data in the message 12 itself. In an example, the ANN is a large language model (LLM) that uses a transformer architecture.

As noted above, the template 130 can also include restrictions that can, for example, require data obfuscation, limit what data can be captured, or require a follow up process to use the data (e.g., request permission from the submitter). Thus, the processing circuitry 110 is configured to evaluate the restrictions against data in the more complete message 140 to determine that no restriction is invoked. For example, if the target process is a sales lead, the restriction can include a requirement to obtain permission from the target of the lead as to whether that person can be contacted. The restrictions can prevent certain data from be kept (e.g., no personally identifying information), can put restrictions on target process behaviors (e.g., respect a “no contact” restriction), or can invoke an additional process (e.g., transforming personally identifying information into an intermediate value that is no longer personally identifying). In an example, the restriction includes data or metadata to contact an entity to which the message 125 pertains. In an example, the metadata is a field indicating consent to contact. In an example, the data is contact information.

The processing circuitry 110 is configured to route the more complete message 140 based on fields in the more complete message. At this juncture, missing data from the message 125, as defined by the template 130, has been gathered by the system 105 to the extent possible, and restrictions on the use or handling of the data, again as defined by the template 130, have been identified or applied. The routing of the more complete message 140 implements the target process by delivering the more complete message 140 to appropriate people or services. For example, if the target process is a sales lead, the routing of the more complete message 140 involves routing the lead to one or more sales teams, such as the sales team 145, the sales team 150, or the sales team 155. The routing can include an evaluation of the competency of the sales team, the capacity (e.g. availability) of the sales team, or technological ability of the sales team (e.g., access to appropriate data sources, communication sources, etc.). As illustrated, the system 105 routed the more complete message to the sales team 145 and the sales team 150 but not the sales team 155.

In the preceding examples, the restrictions from the template 130 did not prevent the more complete message 140 from being routed. However, it is possible that the restrictions do prevent such a routing from being possible. Accordingly, in an example, a second message for the target process can be received and the template 130 for the target process received. Here, when the processing circuitry 110 evaluates the restrictions in the template 130 against data in the second message, the processing circuitry 110 determines that a restriction is invoked and is configured to prevent the second message from being routed based on the restriction being invoked. In an example, preventing the second message from being routed includes copying the second message to a log.

In an example, the processing circuitry 110 is configured to perform a deduplication on received messages (e.g., the message 125). Here, consider that a second message is received that is matched to the message based on one or more data fields. For example, a name normalization process can determine that in the message 125 a short name (e.g., nickname) of the subject person was used and in the second message a given name of the subject person was used, but all other identifying information was the same. When both messages hold the same data, or equivalent data as defined by the template 130 or other predefined process (e.g., the data is within a threshold), then the processing circuitry 110 is configured to discard the second message without routing the second message. However, if the second message includes data that is missing from the message 125, the processing circuitry 110 can be configured to retrieve the missing value from the second message when creating the more complete message 140 as described above.

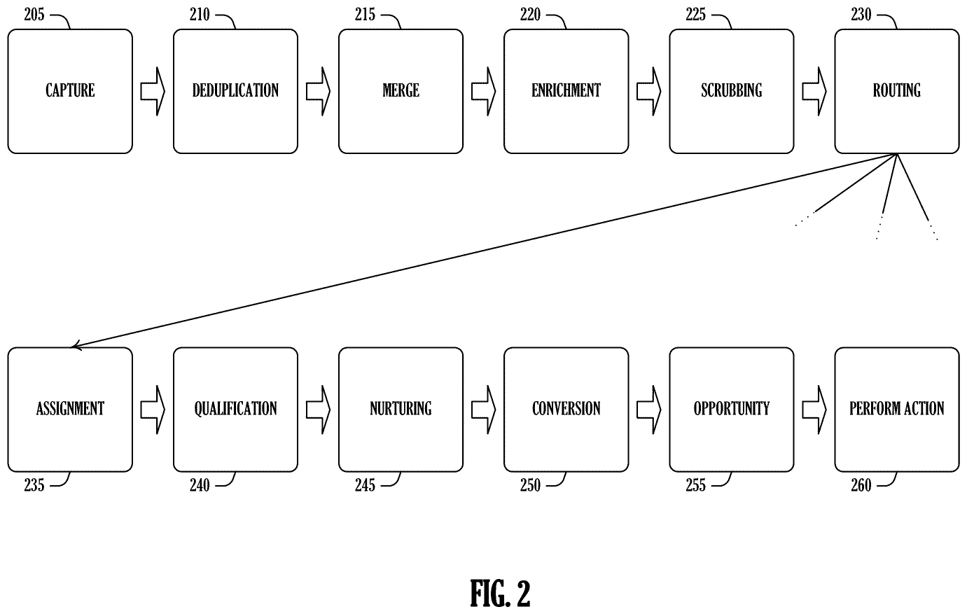

FIG. 2 illustrates an example message flow, according to an embodiment. The illustrated message flow begins with the capture of data (operation 205). The data is then deduplicated (operation 210). Deduplication generally removes redundant (e.g., repeating) data from multiple communications (e.g., message pipelines, data capture rails, etc.). Deduplication can also identify which communications are related to a same entity (e.g., a person that is the subject of a target process). This identification can enable the merging (operation 215) of the captured data as appropriate. For example, if a person has a family identified in one communication and a residential address in another communication, these pieces of data can be merged.

Enrichment (operation 220) can add data that is missing from the data capture operations. Here, a third party database, government entity, or other data source can be consulted to retrieve data missing as defined by the target process. Following enrichment (operation 220), the data is scrubbed (operation 225). Scrubbing refers to the verification of the data for a particular use. Here, verification refers to both whether or not the data is valid and whether or not the data can be used. Thus, for example, if the target process includes a communication component, and permission is needed to communicate with the user, the data will not pass the verification if the permission is lacking. However, if there is permission to contact the subject person, but the communication data is absent or incorrect (e.g., an invalid email address), the data will also fail the verification. In an example, the verification can trigger a process—such as a review, consultation with an external service, or an attempt to acquire permission—to resolve a failure of the verification.

Once the data has passed verification (operation 230), the data is routed (operation 230) to the target process. As illustrated, the target process includes several operations used in a follow up to a subject of the data capture (operation 205). These operations include assignment (operation 235) of the data to an agent (e.g., a person, computer services, etc.) to perform the target process. The assignment (operation 235) can progress to evaluating the qualifications (operation 240) of the agent. During performance of the target process by the agent, nurturing (operation 245) or aid can be provided to the agent. Such aid can include additional information, strategies, or encouragement (e.g., follow up with agent or subject). The success, or conversion (operation 250) of the target process can be monitored or tracked to identify other opportunities (operation 255) for bringing the target process to a conclusion and performing an action (operation 260).

Taking a use case of lead generation and handling, there can be an issue with an inconsistent approach to capturing leads across different lines of business (LOBs), resulting in a lack of end-to-end visibility over the lead lifecycle. Additionally, legacy application infrastructures restrict the ability to quickly modify routing and distribution rules, which impedes operational efficiency.

To address these issues, the heterogenous message bus (e.g., a centralized lead capturing and routing system) can consolidate leads from various sources, ensuring they are ready for assignment. Additionally, the configurable lead distribution assigns leads based on rules tailored to each LOB, enhancing overall effectiveness.

This system enables leads to be captured and routed to the appropriate agent (e.g., banker) at the optimal time, reducing the likelihood of missed opportunities. This approach provides comprehensive visibility and tracking of each lead's status throughout its lifecycle, enabling a deeper understanding of source and channel effectiveness as well as identifying any process-related issues. Furthermore, it enables the business to rapidly update LOB-specific eligibility, routing, and assignment rules, supporting the ability to respond quickly to changing business demands.

In this context, a lead refers to any potential new business opportunity involving both new and existing customers, including referrals. Leads can be captured from a variety of sources, such as referrals, banker-sourced entries, customer web inquiries, or lead lists received via files or APIs. These leads may then be converted into prospects and further transformed into opportunities as they progress through the pipeline.

Lead distribution can be governed by a rules engine that determines routing based on factors such as location, product type, or recipient. The rules engine provides flexibility, enabling routing modifications based on customer preferences, pre-existing agent-client relationships, equitable distribution among team members, or lead source considerations. Lead distribution can be triggered when a lead is received, when an agent has low assignments, or according to a predetermined schedule, with source and business type influencing decisions.

In an example, leads are subjected to data validation and enrichment operations. Here. missing data can be retrieved when possible from third-party sources, or data validation is performed on input leads from channels such as email, web, or application submissions. In an example, a standard API structure maps application fields into a common format, supported by a language model that extracts and standardizes data. Leads lacking sufficient information after validation are moved to a failed set or flagged as errors during API calls. As noted above, lead scrubbing assesses distribution rules, contact permissions, or data quality without removing any information and enrichment adds data from internal databases as needed.

Once leads are assigned, tasks such as lead nurturing, customer follow-ups, or conversion opportunities can be managed by the designated agent. The rules engine can include a distribution rule component that is configured to determine which customer relationship management (CRM) platform receives the lead based on the LOB, or an assignment rule component that is configured to direct leads within the CRM to specific individuals. Each LOB can use different CRM platforms, and leads can be routed accordingly once the data is complete with respect to a given target process.

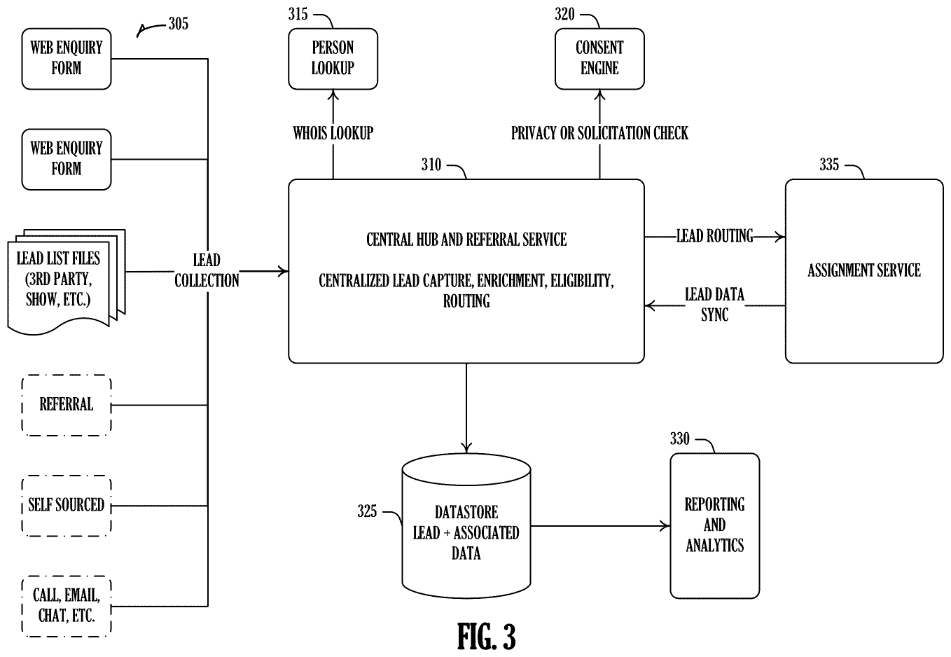

FIG. 3 illustrates an example of component interaction, according to an embodiment. As illustrated, the centralized lead gathering hub 310 accepts lead data from heterogeneous sources 305, enhances the collected data (e.g., via a look up to a person database 315), verifies the right to use the data (e.g., via the consent engine 320), stores the data (e.g., in database 325) from which reporting and analytics can be performed using the reporting and analytics service 330, and the lead is routed (e.g., via the assignment service 335) to an agent.

For example, customer leads can be acquired a variety of sources (the heterogeneous sources 305. The centralized lead gathering hub 310 is configured to aggregate these leads for distribution to an appropriate agent that is both equipped to act on the lead and has bandwidth to act on the lead. In an example, a lead (e.g., each lead) is input into the centralized lead gathering hub 310 with a standard set of characteristics that enable the centralized lead gathering hub 310 to assign the lead to the appropriate agent. In an example, the appropriate agent can be identified based on workload or product expertise.

In an example, the following are examples of data and fields that can be used for the standard set of characteristics for captured data (e.g., a lead):
Input Information (e.g. from the heterogeneous sources 305):
   Contact Information
   Channel
   Source
   Product (if any)
   Consent
   Campaign (if any)
   Offer code (if any)
   Industry (for entity)
   Revenue/Size (for entity)
   Originating app
   Product specific details
   Home lending example
   Purchase Refinance
   Loan Amount
   First time home buyer
   Etc.
   Referral specific details
   Type (follow-up/Warm transfer)
   Written consent obtained (if needed)
   Preferred time to call
   Comments
Some of the standard characteristics are derived rather than captured. These can include:
   Customer or Prospect
   Whether it is Managed or Unmanaged
   LOB
   Duplicity
   Contractability
   Scrub Date
   Data Quality
   Score (how valuable is the lead)
   Service Level Agreement (SLA)
   Ready to Assign
   Assignee
   Expiration date (if any)
   Destination CRM

Additional information that can be associated to the lead during processing can include:
Disposition
Status
Comments
Related customer interactions
Related leads
Related Opportunities

The following are some examples of types of sources that can be included in the heterogeneous sources 305:
Client Request:
   Referral
   Web enquiry form
   Call to 1-800
   Chat
   Email
Customer Activity:
   Event Triggers
   Timed Triggers
   Behavior Triggers
   Online Application
Marketing:
   Campaigns
   Trade show attendees
Third Party
   Partners
   Centers of Influence (COI)
   Data Brokers
Self-Sourced
   Agent (e.g., Banker) Sourced

With respect to the rules used for assigning leads, several factors can be considered to weight the assignment of a given lead. The following are examples of these factors:
Geography
Product
Skill or Certification
Customer type
Customer preference
Book
Lead Source
Date or Time
Readiness
Campaigns
Equity consideration
Queue loading or Limits
   These can be combined with considerations for lead equity, such as:
Quality of Leads
Quantity of leads
Referrals Assigned
Self-sourced leads
   In an example, reassignment can be governed by metrics indicated a lack of progress or failure. Aging (e.g., how old is the lead) can be a factor in lead reassignment.

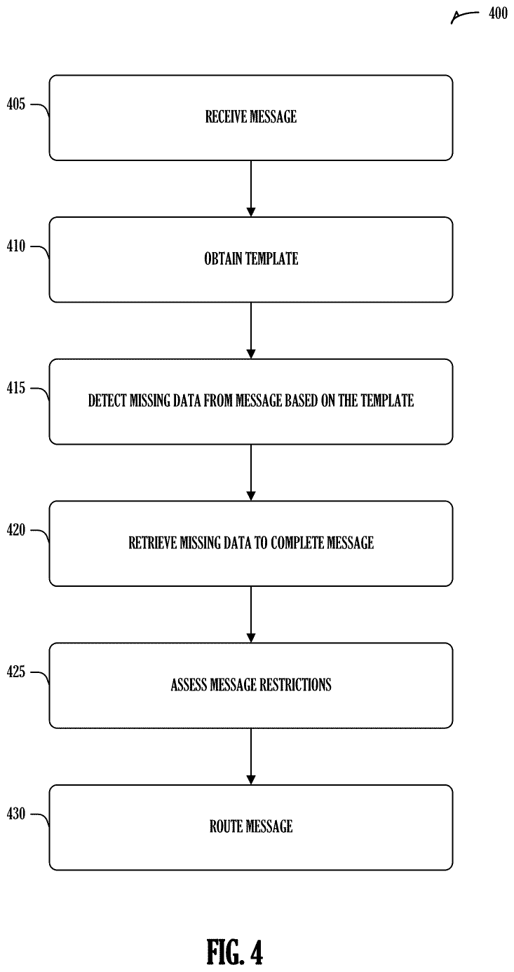

FIG. 4 illustrates a flow diagram of an example of a method 400 for heterogenous message bus, according to an embodiment. The operations of the method 400 are performed by computational hardware, such as those described above or below (e.g., processing circuitry).

At operation 405, receiving a message for a target process.

At operation 410, retrieving a template for the target process, the template including a set of required data fields and a set of restrictions.

At operation 415, detecting that the message is missing a value corresponding to a data field in the set of required data fields. In an example, the message is in a first format and a second message for the target process is in a second format. In an example, the second message is converted to a second more complete message using the template. In an example, the first format is a data structure created by an application programming interface (API). In an example, the second format is a voice recording, a transcript, a video, an image of a paper form, or prose text. In an example, an artificial neural network model is invoked on the second message to extract values from the second message that corresponding to data fields of the template.

At operation 420, retrieving the value to create a more complete message.

At operation 425, evaluating the restrictions against data in the more complete message to determine that no restriction is invoked.

At operation 430, routing the more complete message based on fields in the more complete message.

In an example, the operations of the method 400 can include receiving a second message for the target process. In an example, the operations of the method 400 can include retrieving the template for the target process—the template including a set of required data fields and a set of restrictions—evaluating the restrictions against data in the second message to determine that a restriction is invoked and preventing the second message from being routed based on the restriction being invoked. In an example, preventing the second message from being routed includes copying the second message to a log.

In an example, the operations of the method 400 can include performing a deduplication operation on the second message. In an example, the deduplication operation includes matching the second message to the message based on information held in the message and the second message and discarding the second message without routing the second message. In an example, retrieving the value (operation 420) includes reading the value from the second message.

In an example, the restriction includes data or metadata to contact an entity to which the second message pertains. In an example, the metadata is a field indicating consent to contact. In an example, the data is contact information.

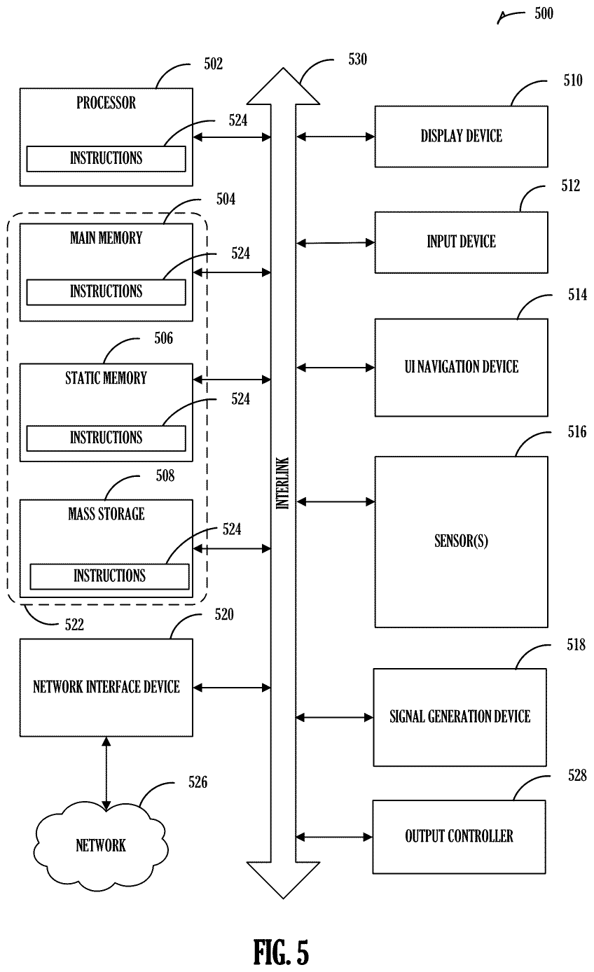

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### Additional Notes & Examples

Example 1 is an apparatus for a heterogenous message bus, the apparatus comprising: a memory including instructions; and processing circuitry that, when in operation, are configured by the instructions to: receive a message for a target process; retrieve a template for the target process, the template including a set of required data fields and a set of restrictions; detect that the message is missing a value corresponding to a data field in the set of required data fields; retrieve the value to create a more complete message; evaluate the set of restrictions against data in the more complete message to determine that no restriction from the set of restrictions is invoked; and route the more complete message based on a field in the more complete message.

In Example 2, the subject matter of Example 1, wherein the message is in a first format, wherein a second message for the target process is in a second format, and wherein the second message is converted to a second more complete message using the template.

In Example 3, the subject matter of Example 2, wherein the first format is a data structure created by an application programming interface (API).

In Example 4, the subject matter of any of Examples 2-3, wherein the second format is a voice recording, a transcript, a video, an image of a paper form, or prose text.

In Example 5, the subject matter of Example 4, wherein the processing circuitry is configured to invoke an artificial neural network model on the second message to extract values from the second message that corresponding to data fields of the template.

In Example 6, the subject matter of any of Examples 1-5, wherein the processing circuitry is configured to receive a second message for the target process.

In Example 7, the subject matter of Example 6, wherein the processing circuitry is configured to perform a deduplication operation on the second message including: matching the second message to the message based on information held in the message and the second message; and discarding the second message without routing the second message.

In Example 8, the subject matter of Example 7, wherein, to retrieve the value, the processing circuitry is configured to read the value from the second message.

In Example 9, the subject matter of any of Examples 6-8, wherein the processing circuitry is configured to: retrieve the template for the target process, the template including a set of required data fields and a set of restrictions; evaluate the set of restrictions against data in the second message to determine that a restriction is invoked; and prevent the second message from being routed based on the restriction being invoked.

In Example 10, the subject matter of Example 9, wherein, to prevent the second message from being routed, the processing circuitry is configured to copy the second message to a log.

In Example 11, the subject matter of any of Examples 9-10, wherein the restriction includes data or metadata to contact an entity to which the second message pertains.

In Example 12, the subject matter of Example 11, wherein the metadata is a field indicating consent to contact.

In Example 13, the subject matter of any of Examples 11-12, wherein the data is contact information.

Example 14 is a method for a heterogenous message bus, the method comprising: receiving a message for a target process; retrieving a template for the target process, the template including a set of required data fields and a set of restrictions; detecting that the message is missing a value corresponding to a data field in the set of required data fields; retrieving the value to create a more complete message; evaluating the set of restrictions against data in the more complete message to determine that no restriction from the set of restrictions is invoked; and routing the more complete message based on a field in the more complete message.

In Example 15, the subject matter of Example 14, wherein the message is in a first format, wherein a second message for the target process is in a second format, and wherein the second message is converted to a second more complete message using the template.

In Example 16, the subject matter of Example 15, wherein the first format is a data structure created by an application programming interface (API).

In Example 17, the subject matter of any of Examples 15-16, wherein the second format is a voice recording, a transcript, a video, an image of a paper form, or prose text.

In Example 18, the subject matter of Example 17, comprising invoking an artificial neural network model on the second message to extract values from the second message that corresponding to data fields of the template.

In Example 19, the subject matter of any of Examples 14-18, comprising receiving a second message for the target process.

In Example 20, the subject matter of Example 19, comprising performing a deduplication operation on the second message including: matching the second message to the message based on information held in the message and the second message; and discarding the second message without routing the second message.

In Example 21, the subject matter of Example 20, wherein retrieving the value includes reading the value from the second message.

In Example 22, the subject matter of any of Examples 19-21, comprising: retrieving the template for the target process, the template including a set of required data fields and a set of restrictions; evaluating the set of restrictions against data in the second message to determine that a restriction is invoked; and preventing the second message from being routed based on the restriction being invoked.

In Example 23, the subject matter of Example 22, wherein preventing the second message from being routed includes copying the second message to a log.

In Example 24, the subject matter of any of Examples 22-23, wherein the restriction includes data or metadata to contact an entity to which the second message pertains.

In Example 25, the subject matter of Example 24, wherein the metadata is a field indicating consent to contact.

In Example 26, the subject matter of any of Examples 24-25, wherein the data is contact information.

Example 27 is a machine readable media including instructions to implement a heterogenous message bus, the instructions, when executed by processing circuitry, cause the processing circuitry to perform operations comprising: receiving a message for a target process; retrieving a template for the target process, the template including a set of required data fields and a set of restrictions; detecting that the message is missing a value corresponding to a data field in the set of required data fields; retrieving the value to create a more complete message; evaluating the set of restrictions against data in the more complete message to determine that no restriction from the set of restrictions is invoked; and routing the more complete message based on a field in the more complete message.

In Example 28, the subject matter of Example 27, wherein the message is in a first format, wherein a second message for the target process is in a second format, and wherein the second message is converted to a second more complete message using the template.

In Example 29, the subject matter of Example 28, wherein the first format is a data structure created by an application programming interface (API).

In Example 30, the subject matter of any of Examples 28-29, wherein the second format is a voice recording, a transcript, a video, an image of a paper form, or prose text.

In Example 31, the subject matter of Example 30, wherein the operations comprise invoking an artificial neural network model on the second message to extract values from the second message that corresponding to data fields of the template.

In Example 32, the subject matter of any of Examples 27-31, wherein the operations comprise receiving a second message for the target process.

In Example 33, the subject matter of Example 32, wherein the operations comprise performing a deduplication operation on the second message including: matching the second message to the message based on information held in the message and the second message; and discarding the second message without routing the second message.

In Example 34, the subject matter of Example 33, wherein retrieving the value includes reading the value from the second message.

In Example 35, the subject matter of any of Examples 32-34, wherein the operations comprise: retrieving the template for the target process, the template including a set of required data fields and a set of restrictions; evaluating the set of restrictions against data in the second message to determine that a restriction is invoked; and preventing the second message from being routed based on the restriction being invoked.

In Example 36, the subject matter of Example 35, wherein preventing the second message from being routed includes copying the second message to a log.

In Example 37, the subject matter of any of Examples 35-36, wherein the restriction includes data or metadata to contact an entity to which the second message pertains.

In Example 38, the subject matter of Example 37, wherein the metadata is a field indicating consent to contact.

In Example 39, the subject matter of any of Examples 37-38, wherein the data is contact information.

Example 40 is a system for a heterogenous message bus, the system comprising: means for receiving a message for a target process; means for retrieving a template for the target process, the template including a set of required data fields and a set of restrictions; means for detecting that the message is missing a value corresponding to a data field in the set of required data fields; means for retrieving the value to create a more complete message; means for evaluating the set of restrictions against data in the more complete message to determine that no restriction from the set of restrictions is invoked; and means for routing the more complete message based on a field in the more complete message.

In Example 41, the subject matter of Example 40, wherein the message is in a first format, wherein a second message for the target process is in a second format, and wherein the second message is converted to a second more complete message using the template.

In Example 42, the subject matter of Example 41, wherein the first format is a data structure created by an application programming interface (API).

In Example 43, the subject matter of any of Examples 41-42, wherein the second format is a voice recording, a transcript, a video, an image of a paper form, or prose text.

In Example 44, the subject matter of Example 43, comprising means for invoking an artificial neural network model on the second message to extract values from the second message that corresponding to data fields of the template.

In Example 45, the subject matter of any of Examples 40-44, comprising means for receiving a second message for the target process.

In Example 46, the subject matter of Example 45, comprising means for performing a deduplication operation on the second message including: matching the second message to the message based on information held in the message and the second message; and discarding the second message without routing the second message.

In Example 47, the subject matter of Example 46, wherein the means for retrieving the value include means for reading the value from the second message.

In Example 48, the subject matter of any of Examples 45-47, comprising: means for retrieving the template for the target process, the template including a set of required data fields and a set of restrictions; means for evaluating the set of restrictions against data in the second message to determine that a restriction is invoked; and means for preventing the second message from being routed based on the restriction being invoked.

In Example 49, the subject matter of Example 48, wherein the means for preventing the second message from being routed include means for copying the second message to a log.

In Example 50, the subject matter of any of Examples 48-49, wherein the restriction includes data or metadata to contact an entity to which the second message pertains.

In Example 51, the subject matter of Example 50, wherein the metadata is a field indicating consent to contact.

In Example 52, the subject matter of any of Examples 50-51, wherein the data is contact information.

Example 53 is at least one machine-readable medium including instructions that, when executed by processing circuitry, cause the processing circuitry to perform operations to implement of any of Examples 1-52.

Example 54 is an apparatus comprising means to implement of any of Examples 1-52.

Example 55 is a system to implement of any of Examples 1-52.

Example 56 is a method to implement of any of Examples 1-52.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A method for a heterogenous message bus, the method comprising:
receiving a message for a target process;
retrieving a template for the target process, the template including a set of required data fields and a set of restrictions;
detecting that the message is missing a value corresponding to a data field in the set of required data fields;
retrieving the value to create a more complete message;
evaluating the set of restrictions against data in the more complete message to determine that no restriction from the set of restrictions is invoked; and
routing the more complete message based on a field in the more complete message.

2. The method of claim 1, wherein the message is in a first format, wherein a second message for the target process is in a second format, and wherein the second message is converted to a second more complete message using the template.

3. The method of claim 2, wherein the second format is a voice recording, a transcript, a video, an image of a paper form, or prose text.

4. The method of claim 3, comprising invoking an artificial neural network model on the second message to extract values from the second message that corresponding to data fields of the template.

5. The method of claim 1, comprising receiving a second message for the target process.

6. The method of claim 5, comprising performing a deduplication operation on the second message including:
matching the second message to the message based on information held in the message and the second message; and
discarding the second message without routing the second message.

7. The method of claim 5, comprising:
retrieving the template for the target process, the template including a set of required data fields and a set of restrictions;
evaluating the set of restrictions against data in the second message to determine that a restriction is invoked; and
preventing the second message from being routed based on the restriction being invoked.

8. A non-transitory machine readable media including instructions to implement a heterogenous message bus, the instructions, when executed by processing circuitry, cause the processing circuitry to perform operations comprising:
receiving a message for a target process;
retrieving a template for the target process, the template including a set of required data fields and a set of restrictions;
detecting that the message is missing a value corresponding to a data field in the set of required data fields;
retrieving the value to create a more complete message;
evaluating the set of restrictions against data in the more complete message to determine that no restriction from the set of restrictions is invoked; and
routing the more complete message based on a field in the more complete message.

9. The non-transitory machine readable media of claim 8, wherein the message is in a first format, wherein a second message for the target process is in a second format, and wherein the second message is converted to a second more complete message using the template.

10. The non-transitory machine readable media of claim 9, wherein the first format is a data structure created by an application programming interface (API).

11. The non-transitory machine readable media of claim 9, wherein the second format is a voice recording, a transcript, a video, an image of a paper form, or prose text.

12. The non-transitory machine readable media of claim 11, wherein the operations comprise invoking an artificial neural network model on the second message to extract values from the second message that corresponding to data fields of the template.

13. The non-transitory machine readable media of claim 8, wherein the operations comprise receiving a second message for the target process.

14. The non-transitory machine readable media of claim 13, wherein the operations comprise performing a deduplication operation on the second message including:
matching the second message to the message based on information held in the message and the second message; and
discarding the second message without routing the second message.

15. The non-transitory machine readable media of claim 14, wherein retrieving the value includes reading the value from the second message.

16. The non-transitory machine readable media of claim 13, wherein the operations comprise:
retrieving the template for the target process, the template including a set of required data fields and a set of restrictions;
evaluating the set of restrictions against data in the second message to determine that a restriction is invoked; and
preventing the second message from being routed based on the restriction being invoked.

17. The non-transitory machine readable media of claim 16, wherein preventing the second message from being routed includes copying the second message to a log.

18. The non-transitory machine readable media of claim 16, wherein the restriction includes data or metadata to contact an entity to which the second message pertains.

19. The non-transitory machine readable media of claim 18, wherein the metadata is a field indicating consent to contact.

20. The non-transitory machine readable media of claim 18, wherein the data is contact information.
